(19) United States
(12) Patent Application Publication
(10) Pub. No.: US 2023/0182794 A1
(43) Pub. Date: Jun. 15, 2023

(54) Renewable Energy Positioning Truck

(71) Applicant: Richard A. Case, San Diego, CA (US)

(72) Inventor: Richard A. Case, San Diego, CA (US)

(21) Appl. No.: 18/079,740

(22) Filed: Dec. 12, 2022

Related U.S. Application Data
(60) Provisional application No. 63/288,504, filed on Dec. 10, 2021.

(51) Int. Cl. B62B 1/14; B66F 9/24

(52) U.S. Cl. CPC B62B 1/14; B66F 9/24; B62B 2203/10

(57) ABSTRACT

A lift truck useful for positioning, placement, and mounting of renewable energy storage devices includes a lifting bracket and tongue raised and lowered by a powered jackscrew lift system. In use, the tongue is placed under a battery system and positioned at the place of installation. Once positioned, the truck is activated, raising the battery system and holding it in place during installation. With the use of the truck, a single technician is able to install the battery system, and risk of physical injury is minimized because the weight of the battery system is entirely supported by the truck during installation.

### RELATED APPLICATION

This application claims priority to U.S. Provisional Pat. Application No. 63/288,504 for a “Renewable Energy Positioning Truck,” filed Dec. 10, 2021, and currently co-pending, the entirety of which is incorporated herein by reference.

### FIELD OF THE INVENTION

The present invention pertains generally to lift trucks. The present invention is particularly, but not exclusively, useful as a lift truck for installing wall-mounted energy storage systems.

### BACKGROUND OF THE INVENTION

Storage battery systems are integral components to residential and commercial renewable energy systems as they provide for the local storage of electrical energy generated during production periods, and usable during periods of low or no energy generation. As a result, the use of sizable battery storage systems has become very common, and it is envisioned that nearly all renewable energy system installations will include the installation of a storage system.

Because these storage systems incorporate large battery banks for the storage of the electrical energy, they are often very heavy. In fact, some of the most commonly used battery storage devices weigh in excess of three hundred pounds each. Installation typically includes mounting the battery system onto a wall where the electrical interconnections can be made easily, and avoiding placement of the battery on the floor or ground where they are more likely to be damaged or subjected to dirt and moisture. However, due to the extraordinary weight of theses battery systems, it is very risky for any installation crew to locate the battery system where it will be installed, and then lift and hold the battery system in position so that it can be securely fastened to the wall. Sometimes, the technicians installing the battery system suffer back injuries from lifting and holding the battery system, or there has to be a three or four man crew which significantly increases the cost of installing a battery system.

In light of the above, it would be advantageous to provide an apparatus that solves the challenges associated with the positioning, placement and mounting of renewable energy storage devices, such as storage battery systems.

### SUMMARY OF THE INVENTION

Disclosed is a lift truck useful for positioning, placement, and mounting of renewable energy storage devices. Preferred embodiments include a lifting bracket and tongue raised and lowered by a powered jackscrew lift system.

In use, the tongue is placed under a battery system or other apparatus to be mounted, and positioned at the place of installation. Once positioned, the truck is activated, raising the battery system or other apparatus and holding it in place during installation.

With the use of the truck, a single technician is able to install the battery system or other apparatus, and risk of physical injury is minimized because the weight of the apparatus is entirely supported by the truck during installation.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a perspective view of a preferred embodiment of a renewable energy positioning truck with a battery system being positioned for installation;

FIG. 2 is a front view of the truck;

FIG. 3 is a side view of the truck, without the wheels and axle in order to illustrate the frame in its entirety;

FIG. 4 is a rear view of the truck, also without the wheels and axle shown;

FIG. 5 is a detail view of the front bottom portion of the truck, illustrating the support plate and lifting bracket;

FIG. 6 is a detail view of the right bottom portion of the truck, illustrating the tongue, lifting bracket, and support plate, along with the union joining them to the powered lift system;

FIG. 7 is a detail view of the rear top portion of the truck, illustrating the connection of the top end of the lift system to the upper plate;

FIG. 8 is a perspective view of the rear top portion of the truck, illustrating the top end of the lift system and a bearing track;

FIG. 9 is a perspective view of the rear bottom portion of the truck, illustrating the wheels and axle, and the motor, gearbox, and brackets of the lift system.

FIG. 10 is a detailed perspective view of the lower portion of the lift system;

FIG. 11 is another detailed view of the lower portion of the lift system;

FIG. 12 is a detail view of a pair of bearings on a bearing track mounted on a vertical rail of the truck;

FIG. 13 illustrates the frame and lift system of the truck;

FIG. 14 illustrates the union that fastens the support plate to the frame of the truck;

FIG. 15 illustrates a charging pack, controller, and remote control of a preferred embodiment of the truck;

FIG. 16 illustrates the jackscrew of a preferred embodiment of a jackscrew lift system;

FIG. 17 illustrates a preferred embodiment of a control panel and battery mount of the truck;

FIG. 18 is a side view of an alternate preferred embodiment of a renewable energy positioning truck, illustrating an extended bottom support plate and the lifting plate; and

FIG. 19 is a rear view of the alternate preferred embodiment of the truck, illustrating the motor, gearbox, electrical track actuator, and other elements of the powered lifting system.

### DETAILED DESCRIPTION

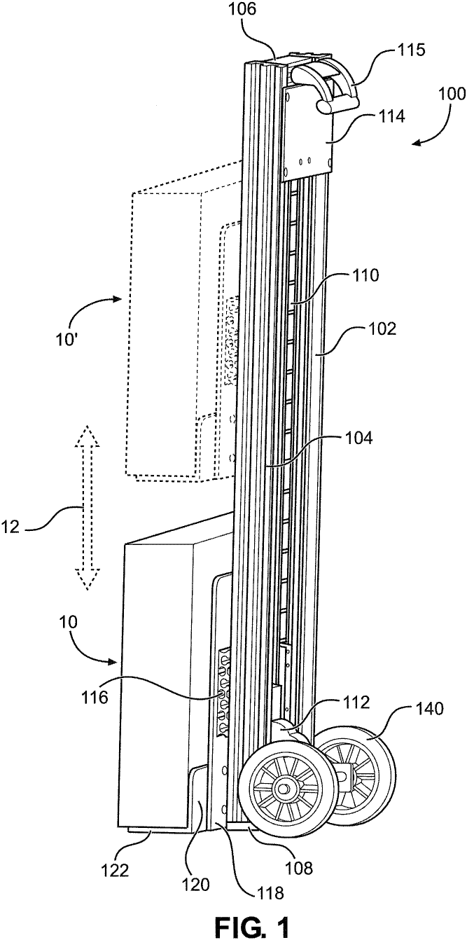

Referring to FIG. 1, the Renewable Energy Positioning Truck of the present invention is shown and generally designated 100 and is used to lift and position a battery system 10 in direction 12. In use, a battery system is placed on truck 100 and then positioned where it will be installed. Then, once in position, the truck is activated and it raises the battery system 10 in direction 12 to position 10′ (shown in dashed lines). Truck 100 then holds battery system 10 in place as the installer secures the battery system to the wall. With the use of the Truck 100, installation of battery system 10 can be achieved by a single technician, while significantly reducing the risk of physical injury as the technician does not have to support the weight of the battery system at all – the weight is entirely supported by truck 100 – allowing the technician to focus exclusively on the physical installation of the battery system on the wall.

Truck 100 includes a rectangular frame having a left vertical rail 102, a right vertical rail 104, an upper rail 106, and a bottom plate 108 all securely fastened together to form a rigid frame. An upper plate 114 is attached to the left vertical rail 102, right vertical rail 104 and upper rail 106 to provide lateral stability to the frame, and to support handle 115. As illustrated, one preferred embodiment of support handle 115 curved downward along the rear side of the frame. As shown in this view, truck 100 also includes wheels 140 to allow for the battery system 10 to be placed on truck 100 and then easily moved to position for installation.

A vertical lift mechanism 110, such as a jackscrew assembly, is positioned within the rigid frame between left and right vertical rails 102 and 104. Vertical lift mechanism 110 includes a drive mechanism 112 which, when activated, moves support plate 116 up and down along the frame. Attached to support plate 116 is a lifting bracket 120 formed to have a tongue 122 that extends at ninety (90) degrees from the lifting bracket, such that tongue 122 is coplanar with the ground when truck 100 is upright. Tongue 122 is thin enough to slide underneath a battery system 10 and be supported thereon.

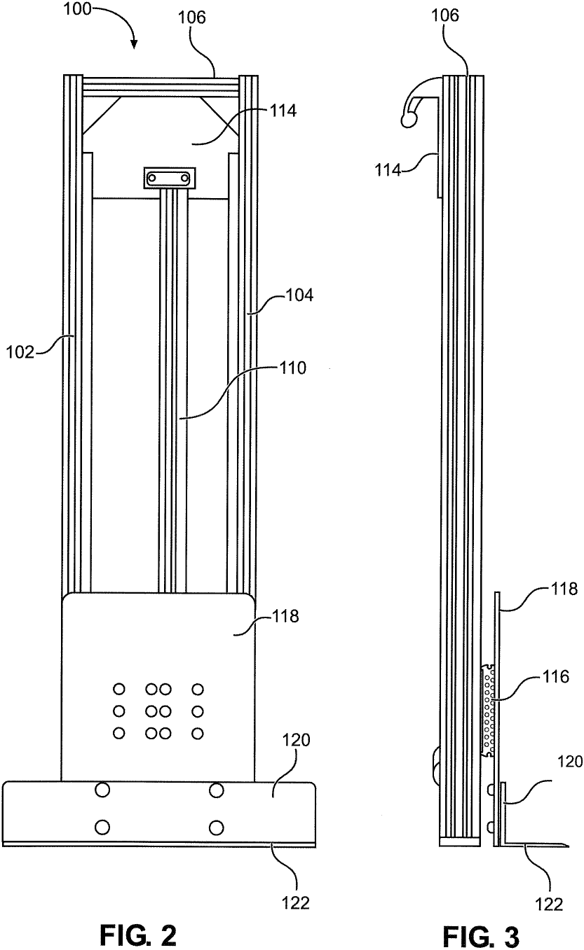

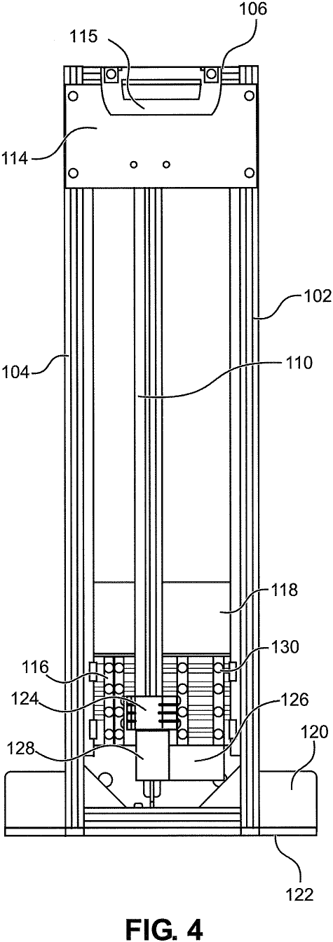

FIGS. 2, 3 and 4 are front, side, and back views of the Renewable Energy Positioning Truck of the present invention 100. From these views, the positioning and cooperation of rails 102, 104, 108 and 108 can be easily appreciated. Also, the positioning of vertical lift mechanism 110 can be easily seen and vertically aligned with the frame of truck 100.

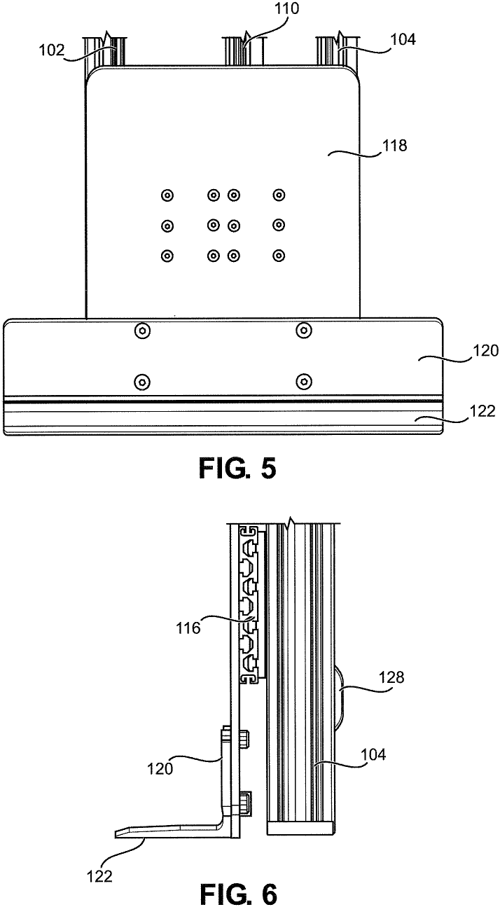

FIG. 5 is a front view of the lower portion of the Renewable Energy Positioning Truck of the present invention 100 showing the support plate 116 and lifting bracket 120 and tongue 122. FIG. 6 is a side view corresponding to FIG. 5, and shows the hardware fastening the support plate and lifting bracket together, and to the vertical lift mechanism 110.

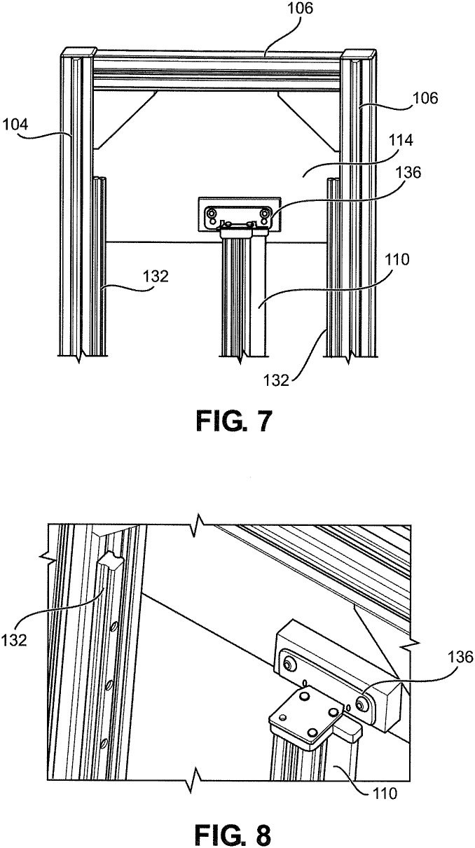

FIG. 7 is a front view of the upper portion of the Renewable Energy Positioning Truck of the present invention, and FIG. 8 is a front perspective view of the upper portion of the Renewable Energy Positioning Truck of the present invention showing the fastening of the vertical lift mechanism 110 to plate 114 and secured with a bracket 136.

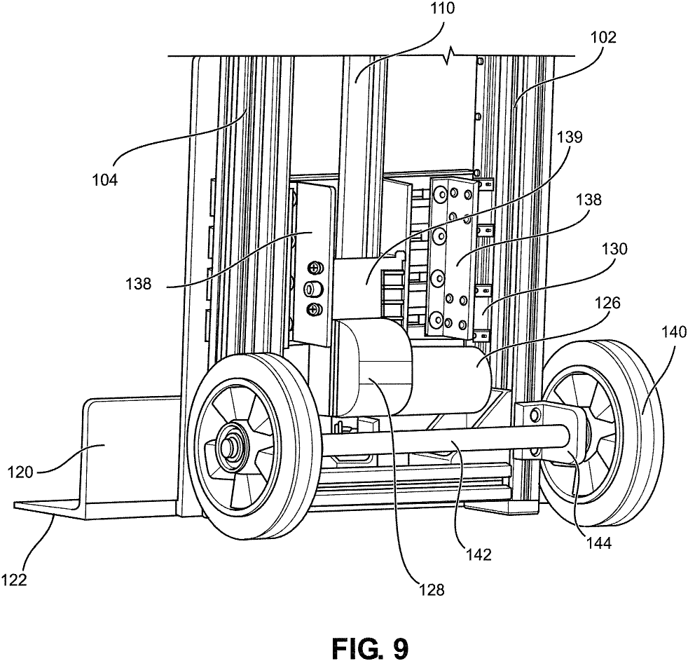

FIG. 9 is a back view of the lower portion of the Renewable Energy Positioning Truck of the present invention showing the mechanical assemblies for the vertical lift mechanism 110. Specifically, vertical lift mechanism 110 is attached to the combination of a drive motor 126 having a gear assembly 128 which translates the rotation of drive motor 126 to rotate the jack screw in the vertical lift mechanism 110 so that the coupling bracket 139 is raised or lowered depending on the direction of rotation of motor 126. Coupling bracket 139 is attached with brackets 138 to support plate 118 with union 116 (shown in FIG. 6) which facilitates the mounting of plate 118 to coupling bracket 139.

Also shown in detail in FIG. 9 are the roller bearings 130 which are positioned over, and ride on, bearing tracks 132. As shown, these bearings 130 include wheels which are formed to engage bearing tracks 132 so that the wheels cannot leave the bearing track, but can only slide along the track. Referring briefly back to FIG. 7, the positioning of the tracks 130 can be running parallel and adjacent the left and right vertical rails 102 and 104.

FIG. 9 also illustrates the attachment of wheels 140 to the frame of Truck 100 via axle 142 and brackets 144 attached to left vertical rail 102 and right vertical rail 104.

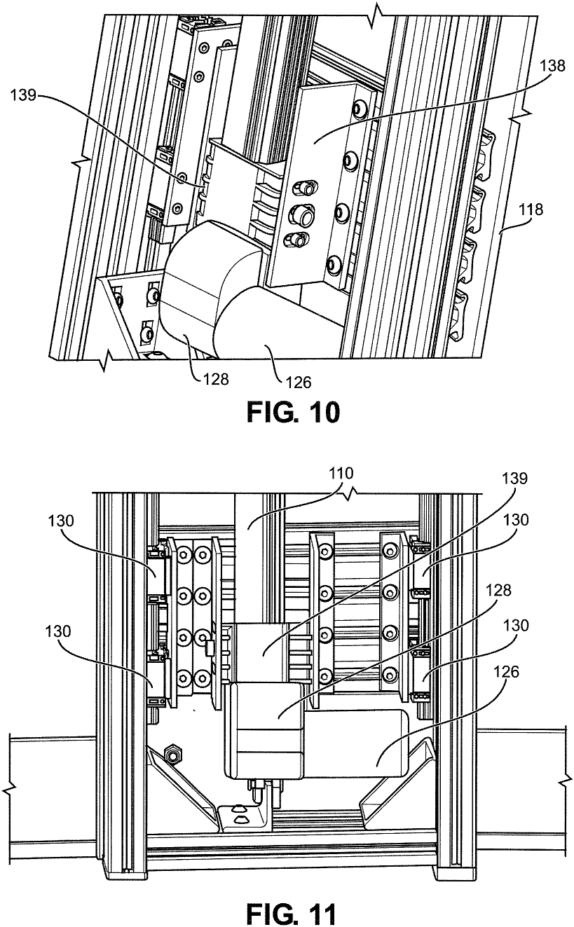

FIG. 10 is back view of the various components of the vertical lifting mechanism 110 of the Renewable Energy Positioning Truck 100 of the present invention. Drive motor 126 is shown in direct mechanical connection to gear assembly 128 which in turn rotationally drives a jackscrew internal to lifting mechanism 110. Coupling bracket 139 is formed to receive jackscrew and as the jackscrew rotates in a first direction, coupling bracket 139 is advanced upwards, and when the jackscrew rotates in a second direction, coupling bracket 139 is advanced downwards. Using this vertical lift mechanism 110, the position of a battery system 10 on tongue 122 can be very precisely controlled.

Referring to FIG. 11, the roller bearings 130 and corresponding bearing tracks 132 are seen. Using a combination of two roller bearings 130 on each side of the Renewable Energy Positioning Truck 100, support plate 118 is maintained in alignment with vertical rails 102 and 104 any torque that might result from the side-to-side offsetting of the battery system 10 on tongue 122 does not result in any tilting of the battery system when being installed. It is also to be appreciated that more than four roller bearings 130 may be used, and that other bearing systems may be incorporated into the Renewable Energy Positioning Truck of the present invention without departing from the present invention.

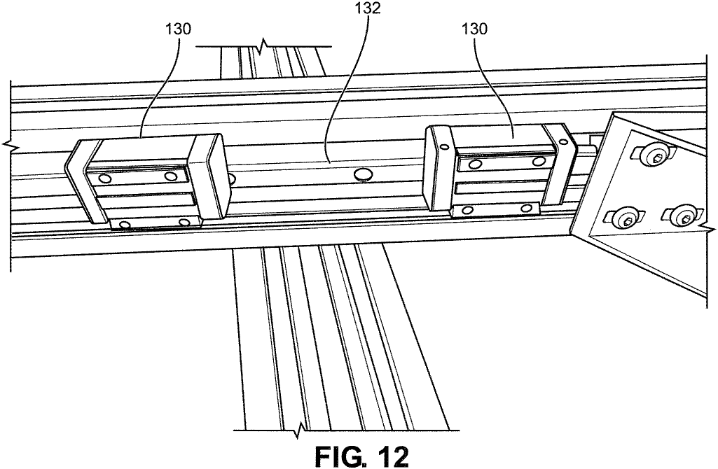

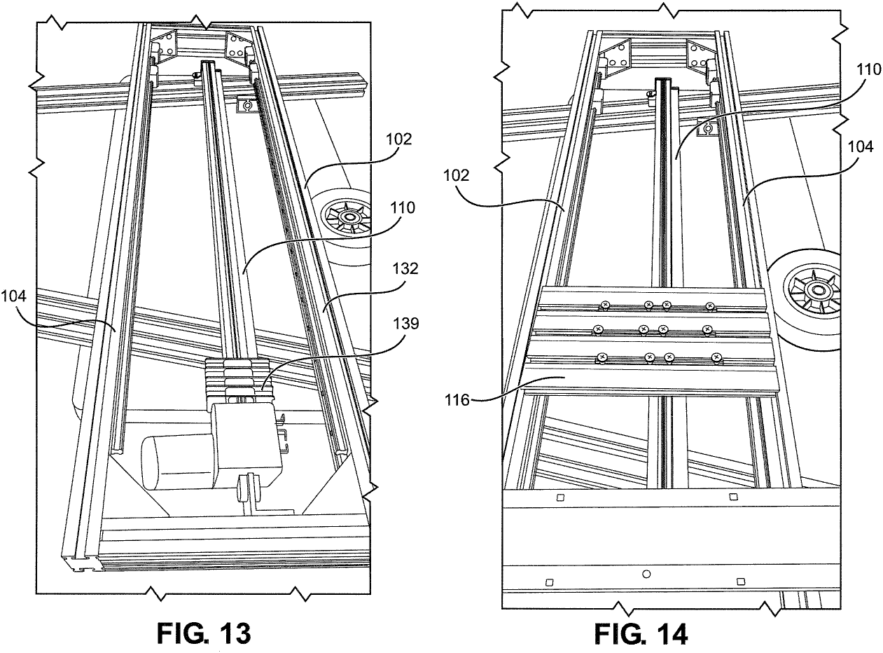

FIGS. 12, 13 and 14 are illustrations showing detailed views of portions of a preferred embodiment of a Renewable Energy Positioning Truck. FIGS. 12 and 13 are enlarged views of the roller bearings 130 that ride on bearing tracks 132. FIG. 14 is a front view of the union 116 showing the fasteners to receive support plate 118.

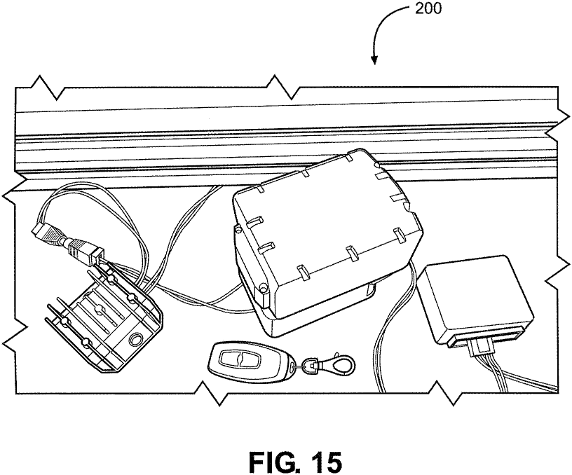

FIG. 15 is an illustration of the rechargeable battery pack used to drive motor 126, and the controller and remote control device to control the operation. Specifically, a technician can utilize the remote to raise and lower the tongue 122 as needed.

A typical installation of a battery system 10 includes a technician approaching a battery system with the Renewable Energy Positioning Truck 100 of the present invention, and positioning the tongue 122 under the battery system such that the battery system rests against plate 120 and support plate 118. Once in position, the technician pulls handle 115 back, raising the battery system from the ground, and rolls the battery system into position against the wall beneath where it will be installed on the wall. Once in position, the technician utilizes the remote to raise the battery system 10 in direction 12 to the proper height. Once at the proper height, the technician releases the remote control and the vertical lift mechanism stops and maintains the tongue at the selected height. The technician can then proceed to secure the battery system to the wall according to the manufacturers specific installation guidelines. Once in position and firmly secured to the wall, the technician can activate the remote control to lower the vertical lift mechanism 110 back to its lowest position, and then removed from the area.

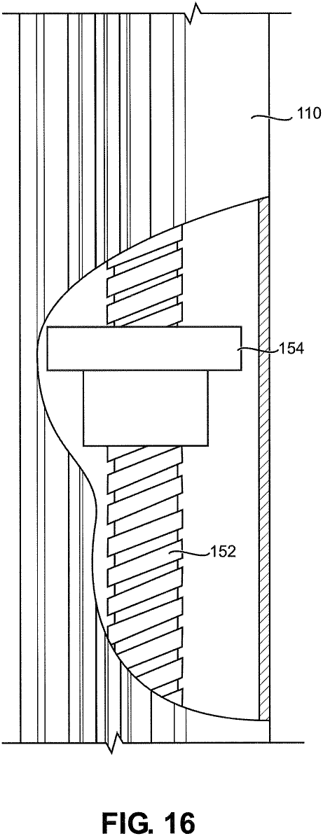

Referring now to FIG. 16, a cutaway view of a portion of a preferred embodiment of vertical lift mechanism 110 is illustrated, showing a jackscrew 152. As jackscrew 152 is turned by drive motor 126 (not shown in FIG. 16) and gear assembly 128 (not shown in FIG. 16), nut 154 is raised or lowered, thereby raising or lowering coupling bracket 139 (not shown in FIG. 16) which is engaged to jackscrew 152 via nut 154.

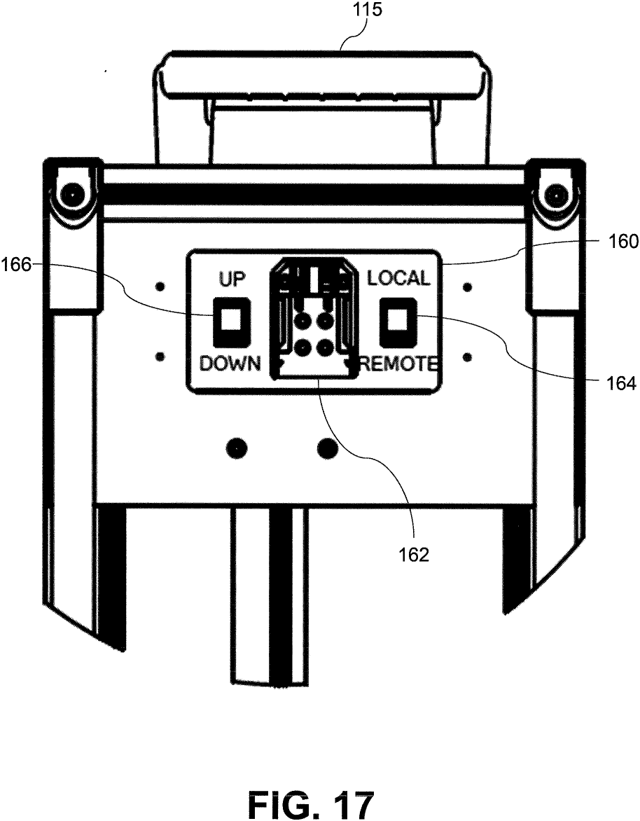

Referring now to FIG. 17, a close up view of the rear side of a preferred embodiment of upper plate 114 is illustrated, showing control box 160. Control box 160 includes battery mount 162 for connecting the battery pack (shown in FIG. 15), which is a rechargeable M18 type battery in preferred embodiments.

Also present in control box 160 are switches 164 and 166. Switch 164 toggles the manner of operation of the lift mechanism 110 between local and remote operation. In other words, switch 164 has at least two positions: In a first position, switch 166 is used to operate the lift mechanism 110, while in a second position, lift mechanism 110 is operated by a remote control (shown in FIG. 15).

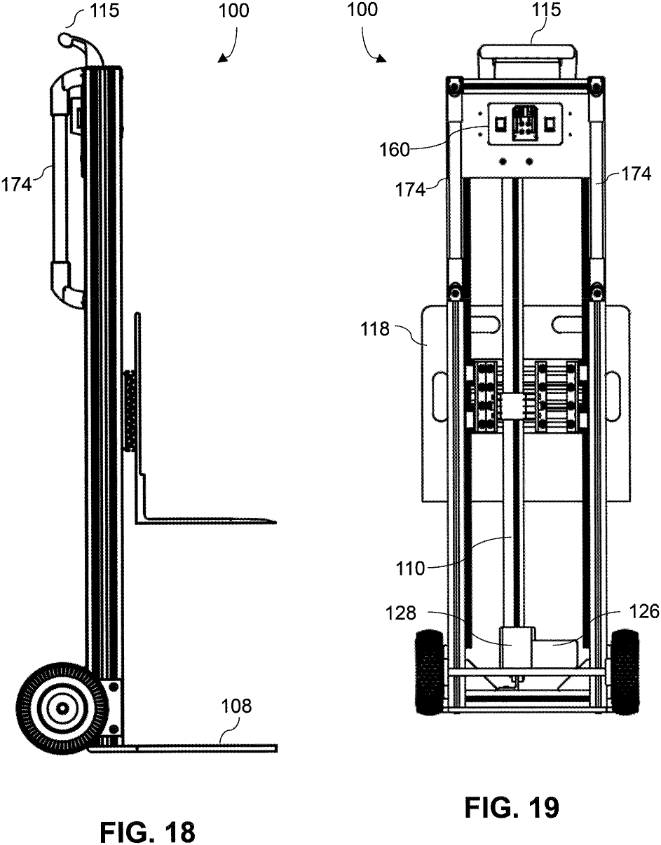

Referring now to FIG. 18, an alternative preferred embodiment of truck 100 is illustrated, in which bottom plate 108 extends outward in front of truck 100, similar to tongue 122 of support plate 118. Unlike plate 118 and its tongue 122, this extended bottom support plate 108 is fixed at the bottom of truck 100 and does not move when lift mechanism 110 is activated, but rather remains in place to provide additional stability to truck 100.

Side handles 174 provide an additional grasping point for an operator in order to allow truck 100 to be more easily maneuvered into place for installation of a battery system.

Referring now to FIG. 19, mechanical lift system 110 is an electrical track actuator in preferred embodiments. A particular preferred embodiment implemented with a jackscrew system has been described in some detail. However, the use of other types of linear actuator are fully contemplated.

While there have been shown what are presently considered to be preferred embodiments of the present invention, it will be apparent to those skilled in the art that various changes and modifications can be made herein without departing from the scope and spirit of the invention. Moreover, additional embodiments with the various possible combinations of features of the embodiments described herein are fully contemplated.

What is claimed is:

1. A lift truck, comprising:
a rigid frame having a top and a bottom;
a support plate;
a lifting bracket attached to the support plate;
a tongue extending at ninety degrees from the lifting bracket; and
a vertical lift mechanism having a drive mechanism and configured to raise and lower the support plate along the frame.

2. The lift truck of claim 1, wherein the vertical lift mechanism comprises a jackscrew assembly.

3. The lift truck of claim 1, further comprising a support handle at the top of the frame, the support handle curving downwards along a rear side of the frame.

4. The lift truck of claim 1, further comprising an upper plate attached to the frame proximate the top of the frame.

5. The lift truck of claim 4, wherein the vertical lift mechanism is secured to the upper plate with a bracket.

6. The lift truck of claim 4, further comprising a union with fasteners configured to receive the support plate, thereby engaging the support plate to the vertical lift mechanism.

7. A lift truck, comprising:
a frame comprising:
a left vertical rail,
a right vertical rail,
an upper rail, and
a bottom plate;
a vertical lift system positioned within the frame between the left vertical rail and the right vertical rail, the vertical lift mechanism having a coupling bracket attached to a left support plate bracket and a right support plate bracket;
a support plate liftably engaged to the left support plate bracket and right support plate bracket; and
a lifting bracket attached to the support plate and configured to support a load.

8. The lift truck of claim 7, wherein the support plate is engaged to the left support plate bracket and the right support plate bracket through a union having fasteners.

9. The lift truck of claim 7, further comprising a support handle at the top of the frame, the support handle curving downwards along a rear side of the frame.

10. The lift truck of claim 7, wherein the vertical lift system comprises a jackscrew assembly.

11. The lift truck of claim 10, further comprising:
a left bearing track adjacent the left vertical rail;
a right bearing track adjacent the right vertical rail;
a plurality of left roller bearings, each attached to the left support plate bracket and having wheels engaged to the left bearing track; and
a plurality of right roller bearings, each attached to the right support plate bracket and having wheels engaged to the right bearing track.

12. The lift truck of claim 11, wherein the vertical lift system further comprises a drive motor and gear assembly configured to engage a jackscrew of the jackscrew assembly, thereby raising and lowering the coupling bracket, left support plate bracket, right support plate bracket, support plate, and lifting bracket.

13. The lift truck of claim 12, wherein the vertical lift system is operable by remote control.

14. The lift truck of claim 12, further comprising an upper plate attached to the frame proximate the top of the frame, wherein the vertical lift system is secured to the upper plate with a bracket.

15. A lift truck, comprising:
a frame comprising:
a left vertical rail,
a right vertical rail,
an upper rail,
a bottom plate,
an upper plate attached to the left vertical rail, the right vertical rail, and the upper rail,
a handle positioned at the upper plate,
an axle attached to the left vertical rail and the right vertical rail with brackets,
a left wheel attached to a left end of the axle, and
a right wheel attached to a right end of the axle;
a support plate liftably engaged to the left support plate bracket and right support plate bracket;
a lifting bracket attached to the support plate having a tongue coplanar with ground and configured to support a load comprising a renewable energy storage system; and
a vertical lift system positioned within the frame between the left vertical rail and the right vertical rail, the vertical lift mechanism having a coupling bracket attached to a left support plate bracket and a right support plate bracket, and comprising a drive motor and gear assembly configured to raise and lower the coupling bracket, left support plate bracket, right support plate bracket, support plate, and lifting bracket.

16. The lift truck of claim 15, wherein the vertical lift system comprises a jackscrew assembly.

17. The lift truck of claim 15, further comprising:
a left bearing track adjacent the left vertical rail;
a right bearing track adjacent the right vertical rail;
a plurality of left roller bearings, each attached to the left support plate bracket and having wheels engaged to the left bearing track; and
a plurality of right roller bearings, each attached to the right support plate bracket and having wheels engaged to the right bearing track.

18. The lift truck of claim 15, wherein the vertical lift system further comprises a removable rechargeable battery pack configured to power the drive motor.

19. The lift truck of claim 15, further comprising a remote control operable to cause the vertical lift system to raise and lower the lifting bracket.

20. The lift truck of claim 15, further comprising an upper plate attached to the frame proximate the top of the frame, wherein the vertical lift system is secured to the upper plate with a bracket.
